(19) United States
(12) Patent Application Publication
(10) Pub. No.: US 2023/0081797 A1
(43) Pub. Date: Mar. 16, 2023

(54) COMPUTER IMPLEMENTED METHOD AND SYSTEM FOR RETAIL MANAGEMENT AND OPTIMIZATION

(71) Applicant: Deepspatial INC., Toronto (CA)

(72) Inventors: Bushra Zaman, Bengaluru (IN); Rajiv Muradia, Toronto (CA); Rahul Kushwah, Toronto (CA)

(21) Appl. No.: 17/945,641

(22) Filed: Sep. 15, 2022

Related U.S. Application Data
(60) Provisional application No. 63/244,524, filed on Sep. 15, 2021.

(51) Int. Cl. G06Q 10/06; G06Q 30/02

(52) U.S. Cl. CPC G06Q 10/06375; G06Q 30/0201; G06Q 30/0205

(57) ABSTRACT

Disclosed is a computer implemented system and method for retail management. The computer implemented system and method for retail management provides data driven and insightful decisions for businesses by implementing an Artificial Intelligence (AI) Platform. The AI platform utilizes the tacit industry knowledge with geospatial information and proprietary AI algorithms to make data driven decisions. In an embodiment, the computer implemented system and method includes DBAS Engine for retail management, prediction, and business optimization. The computer implemented system and method for retail management provides a layered set of solutions to drive the bottom-line revenue and further adds value by identifying new markets for expansion. In addition, the layered solution implemented by using AI algorithms identify the preferred customer profiles to serve targeted customers in a personalized way. The DBAS Engine provides a user interface, which includes all essential tools for business analytics to provide a full spectrum of features for a comprehensive user experience.

### RELATED APPLICATIONS

This application is related to the following:
1. Provisional Application Ser. No. 63/244,524, filed Sep. 15, 2022 (Parent Provisional);

This application claims priority to the Parent Provisional, and hereby claims benefit of the filing date thereof pursuant to 37 CFR § 1.78(a)(4).

The subject matter of the Parent Provisional and the Related Application, each in its entirety, is expressly incorporated herein.

### FIELD OF THE INVENTION

The present application is directed to a software implemented system and method of retail management with enhanced user experience. The software implemented system and method disclosed herein provides a layered solution to retail planning and organization. By providing layered solution for retailing, the software implemented system and method of retail management drives top-line revenue and further adds value by identifying new markets for expansion and a result improves the bottom-line. Additionally, the software implemented system and method identifies the right customer profiles to serve targeted customer in a personalized way. Furthermore, the software implemented system and method uses built in advanced AI powered platforms that allow businesses to make data driven decisions using geospatial data as well as proprietary data.

### BACKGROUND

Advancements in information technology have revolutionized the landscape for e-commerce and retail. As digital transformations enrich and enhance existing businesses, retail businesses face new frontiers for expansion along with a novel constraint—location. As organizations adopt omni-channel strategies to deliver value, traditional retail needs to adapt to find novel solutions to thrive. In 2019, retailers in the United States announced over 9,000 store closings. In 2020, the onset of COVID-19 only exacerbated the problem. So far, over 27 retailers across North America have filed for bankruptcy, including legacy giants such as J. C. Penney, J. Crew, and Forever 21. The goal of a successful business isn't to beat the competition, but to altogether escape it. The next revolution in retail will come from a better understanding and interpretation of what is the lifeblood of any organization—data. As corporate restructuring ensues, players need to dive deep to address the underlying causes of the crisis in retail industry, which can be attributed to some key factors discussed below.

Shift to e-Commerce. The shift to e-commerce has revolutionized consumer spending across all sectors in retail. By eliminating middlemen and advancing superior inventory management, e-commerce websites are able to cut prices for consumers, while maintaining a healthy profit-margin.

Over-Malled and Underserved. Retail, in large part, initially grew because of the “mall” effect, where a unified shopping experience that afforded greater choice and variety drove sales. With a location constraint, firms often had to spend heavily to maintain inventory and were susceptible to price wars with competitors housed in the same shopping mall. The eventual result was decaying malls with high vacancy rates and low consumer traffic levels.

Overstocked and Undersupplied. Dealing with, and managing intricate supply chains across physical stores, led to huge capital expenditures which reduced margins and afforded a poorer in-store experience. “Keeping up” with the latest inventory served as a major challenge, and stores were often oversupplied with redundant merchandise no longer in demand.

Poor Management. The culmination of the above factors led firms to aggressively cut costs to maintain margins, which often meant understaffed stores and an inferior customer experience. The aggressive expansion of a firm's balance sheet led to overleveraged financing that put further pressure on management to cut costs and shut stores to maintain margins.

COVID-19. The landscape of retail business was completely changed due to COVID-19. Opening a new retail outlet is a capital-intensive activity. If a store does not perform well and results in closure of that location, it could result in further expenses which maybe up to 50% of the cost of setting up the store to begin with. Hence, choosing a location which could assist in creating a profitable and successful store became a critical choice. Traditional approach of identifying a potential store location relies mainly on presence of company's own current stores and that of major competitors.

Performance of a particular store may depend on a lot of things, such as awareness of the brand in the locality, competition, services & inventory within the store and most importantly the demographic and economic profile of the customers who live in the area being served by the store. The disclosed computer implemented system and method for retail management takes into account all such quantitative and many qualitative parameters in a comprehensive way to come up with an optimal location that can support a successful store and build a brand presence. A data driven approach is taken which accounts for the external factors related to the store's catchment area like demographics, purchasing power of potential customers, competition etc. to identify location with highest chances of success. The solution is applicable as well as customizable to cover all types of cities and regions of the country, is scalable, user friendly as it helps the user of the system in making a data driven decision through use of solution's inbuilt features and functionalities to create what-if scenarios and apply filters where the system may handle all statistical complexities at the backend, and is flexible to incorporate new data streams, if and when available.

The disclosed computer implemented system and method for retail management provides mechanisms to help categorize and differentiate the successful and unsuccessful stores. The AI platform built in the computer implemented system and method for retail management allows to extract insights using collected and proprietary data to enable rational data driven decisions. Taking store performance as a dependent variable, it models it against independent variables related to customer demographic, catchment attributes, competition and commercial activity around the store's geographic area.

### SUMMARY OF THE INVENTION

Disclosed is a computer implemented system and method for retail management. The computer implemented system and method for retail management provides data driven and insightful decisions for businesses by implementing an Artificial Intelligence (AI) Platform. The AI platform utilizes the tacit industry knowledge in combination with geospatial information and proprietary AI algorithms to help businesses make data driven decisions.

In some embodiments, the computer implemented system and method addresses the capabilities of a deep-learning geospatial artificial intelligence engine (DSAI/DBAS Engine) for retail management. The computer implemented system and method for retail management provides a unique and novel layered set of solutions. The layered solution helps with increasing the bottom-line revenue and may further add value by identifying new markets for expansion. In addition, the layered solution implemented through use of AI algorithms may identify the preferred customer profiles to serve targeted customers in a personalized way. The DSAI/DBAS Engine may provide a user friendly and novel User Interface/User Experience (UI/UX) platform, which may include all essential tools for business analytics to provide a full featured enhanced user experience.

In some embodiments, the DSAI/DBAS Engine may also implement neuro linguistic programming (NLP) features for business analytics to provide natural language processing for answering questions posed by the user in natural language.

In some embodiments, the DSAI/DBAS Engine of the computer implemented system and method for retail management may include one or more AI algorithms for processing geospatial data for solving the problem of distance and direction. The DSAI/DBAS Engine may access various forms of data, which allows the computer implemented application to identify highly specific, extremely valuable information using geospatial information systems and custom maps.

In some embodiments, the computer implemented system and method for retail management integrates the large, disparate data sets which may contain geographical data points provided as input and may integrate it with the existing propriety data sets to map out geographies with a high precision of granularity. Furthermore, the computer implemented system and method for retail management may use location intelligence and may detect patterns and trends to identify areas of interest.

In some embodiments, the computer implemented system and method for retail management may help in solving optimization problems. In addition, the computer implemented system and method for retail management may help in identifying hidden markets and identifying new industry verticals. The identification of new industry verticals adds value in the form of secondary and tertiary externalities as well, e.g., a customer wants to improve the delivery supply chain which can be achieved through route optimization. This can be achieved by layering data from infrastructure, traffic, and end-point coordinates. As an example, assume that a firm's delivery network traverses 10,000 miles to successfully complete all deliveries. A 10% improvement in route optimization will bring the total miles travelled to 9,000, but also lead to a 10% improvement in delivery times overall and reduce the total transport time. Moreover, not only does it allow the firm to reduce its capital expenditure (fuel, maintenance, insurance, etc.) but also allows the firm to expand its existing set of operations. The shift in the upper bound of a firm's maximum capacity can then lead to network effects which further catalyze growth prospects.

In embodiments, the artificial intelligence technology implemented in the computer implemented system and method for retail management may begin with data ingestion and collection. As next step, the collected data is categorized for better interpretation and analysis. Subsequently, the computer implemented system and method for retail management may use feature engineering, where the method integrates the client's data with DSAI/DBAS Engine propriety data to map it geo-spatially. Thereafter, various artificial intelligence and machine learning tools are used to test different hypotheses. For example, testing variables against one another to differentiate factors, which are affecting the business. Finally, the findings are presented to answer key questions in the form of actionable insights on a dashboard.

In embodiments, the DSAI/DBAS Engine leverages the power of artificial intelligence and machine learning to provide business intelligence and data driven decision making for business operations. By transforming existing gathered data and the legacy data and putting this data within the context of a specific geography, the solutions drive value by allowing firms to optimize capital allocation, improve margins, and enter new markets.

In some embodiments, the DSAI/DBAS Engine may conduct geo-demographic customer profiling to understand how customers in different geographies interact with the company's products. From a market analysis in specific geographies to market entry in a new location, the computer implemented system and method for retail management helps to identify working and non-working use cases in each geography.

In some embodiments, the DSAI/DBAS Engine includes a methodology for recommending right locations for market entry and market expansion. The proprietary datasets in combination with various factors may create a distinct geo-location profile for a business. The tool may recommend the optimal site, geo-marketing strategy, as well as right strategies and partners for expansion.

The computer implemented system and method for retail management further includes a price recommendation engine. The novel and unique price recommendation engine helps a business to drive sales by simplifying the nuances of the geo-demographic performance. The geospatial insights will facilitate the business with a better understanding of its products in segmented geographies and allow the business to price the products competitively and better customers service.

In some embodiments, the DSAI/DBAS Engine may include a methodology for recommending inventory management. The predictive algorithms coupled with alternative data may allow the business entities to identify how, when, and most importantly the effect of changing trends. This allows business entities to reduce capital expenditure on redundant inventory and keep accurate track of current stock.

In some embodiments, the DSAI/DBAS Engine may include a social listening feature. It may leverage the power of social media to provide a comprehensive analysis of how customers feel about the client's product, so that the client may personalize the marketing efforts and create partnerships in customer's native locations.

### BRIEF DESCRIPTION OF THE DRAWINGS

FIG. 1 illustrates an environment of a retail management system in an embodiment of the present invention;

FIG. 2 illustrates different parts of the retail management system in an embodiment of the present invention;

FIG. 3A illustrates different parts of a retail module in an embodiment of the present invention;

FIG. 3B illustrates a DSAI/DBAS Engine in an embodiment of the present invention;

FIG. 4 illustrates a process of retail management in an embodiment of the present invention;

FIG. 5 illustrates different characteristics of customers to predict feasibility a store location in an embodiment of the present invention.

FIG. 6 illustrates a table of different characteristics of customers for prediction of a store location in an embodiment of the present invention;

FIG. 7 illustrates the functional architecture of DSAI/DBAS platform in an embodiment of the present invention;

FIG. 8 illustrates another architecture of the DSAI/DBAS platform in an embodiment of the present invention;

FIG. 9 illustrates a functional flow of the steps involved in evaluating a store location in an embodiment of the present invention;

FIG. 10 illustrates a process flow of the steps involved in evaluation of a store location in an embodiment of the present invention;

FIG. 11 illustrates an exemplary case of data exploration for small format stores in an embodiment of the present invention;

FIG. 12 illustrates a DSAI/DBAS Engine performing a correlation analysis of the annual store level sales data with respect to floor area;

FIG. 13 illustrates the contribution of the different product categories to sales;

FIG. 14 illustrates a heat correlation map of the product subcategories in the food product category to sales;

FIG. 15 illustrates a heat correlation map of the product subcategories inside the food category;

FIG. 16 illustrates the commercial Points of Interests (POI) population density map for an exemplary city;

FIG. 17 illustrates the locality level property rates data overlaid on top of commercial density contours for an exemplary city;

FIG. 18 illustrates a population density map to be used to factor in the demographics of the city;

FIG. 19 illustrates the asset data set of households of an exemplary city in an embodiment of the invention;

FIG. 20 illustrates the affluence distribution for the exemplary city in an embodiment of the present invention;

FIG. 21 illustrates a location of current and competition stores for an exemplary city in an embodiment of the present invention;

FIG. 22 shows the exemplary catchment area calculations for a city in an embodiment of the invention;

FIG. 23 illustrates a catchment area of 500 m around a store location in an embodiment of the present invention;

FIG. 24 illustrates the use of significant features in an exemplary case of feature engineering for a small store location in an embodiment of the present invention;

FIG. 25 illustrates an exemplary case of significant features obtained after running statistical analysis;

FIG. 26 illustrates an exemplary case of the correlation heat map of one or more significant features after highly correlated variables are discarded;

FIG. 27 illustrates another correlation heat map of significant features of an exemplary case after the highly correlated features are removed in an embodiment of the present invention;

FIG. 28 illustrates the Kendells Tau metric for various catchment areas in an embodiment of the present invention;

FIG. 29 illustrates an exemplary model of feature importance for the model with catchment radius 300 m;

FIG. 30 is an exemplary model where the catchment radius is analyzed with respect to features for model validation;

FIG. 31 illustrates the new locations with site potential marked from low to high in an embodiment of the present invention;

FIG. 32 illustrates the DSAI/DBAS Engine provides a Snapshots from LOCI identifying new store locations with given constraints in an embodiment of the present invention;

FIG. 33 illustrates an exemplary UX/UI showing the performance of the brand in an exemplary city.

### DETAILED DESCRIPTION OF THE DRAWINGS

The description contains specific information pertaining to exemplary implementations of the invention. However, the exemplary implementations are non-limiting and the disclosed invention can be implemented in manners different than specifically discussed herein. The enablement of the invention is illustrated with accompanying drawings, wherein the like numerals in the drawings indicate corresponding or like elements unless noted otherwise.

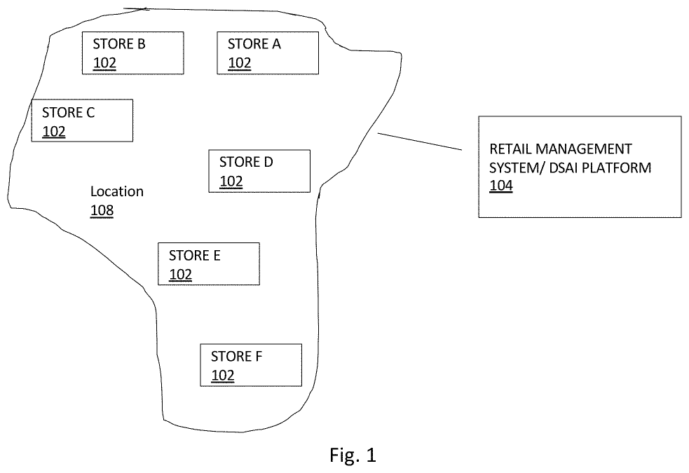

FIG. 1 illustrates an environment of a retail management system/DSAI/DBAS platform in an embodiment of the present invention. A retail management system/DSAI/DBAS platform 104 evaluates the different parameters related to retail management such as, but not limited to, store location, inventor management, sales, for a geographical location 108. The geographical location 108 includes multiple stores 102 such as store A, store B and store C as shown in FIG. 1. Each store, such as the store A, the store B, and the store C may be of different sizes and types. the retail management system takes into account multiple factors to predict one or more parameters for retail management such as optimum inventory, new store location based on different parameters associated with demographics, consumer behavior, commercial activity, competition etc.

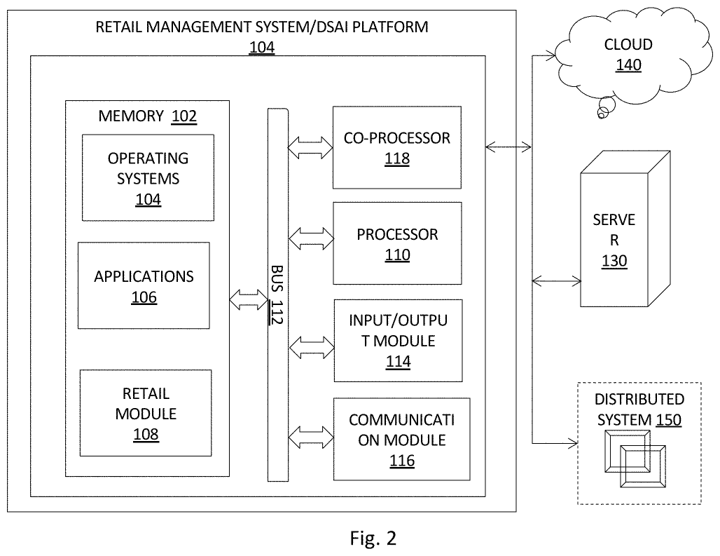

FIG. 2 illustrates different parts of the retail management system 104/DSAI/DBAS platform in an embodiment of the present invention. The retail management system 104/DSAI/DBAS platform is networked with a cloud 140, a server 130, a distributed system 150. The retail management system 104/DSAI/DBAS platform includes a memory 102 comprising an operating system 104, a one or more applications 106, and a retail module 108 interfaced with an internal bus 112 and connected to a processor 110, a one or more input/output devices 114, a co-processor 118 and one or more communication devices 116. The internal bus 120 carries data and supplies electrical current among different components.

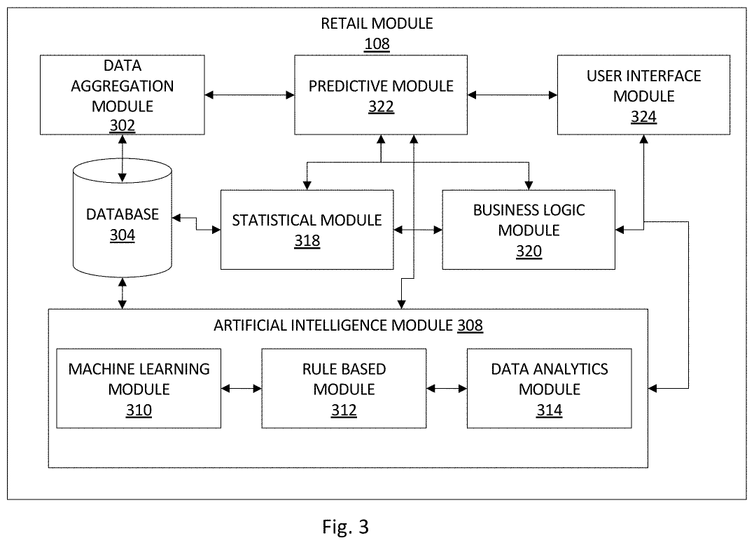

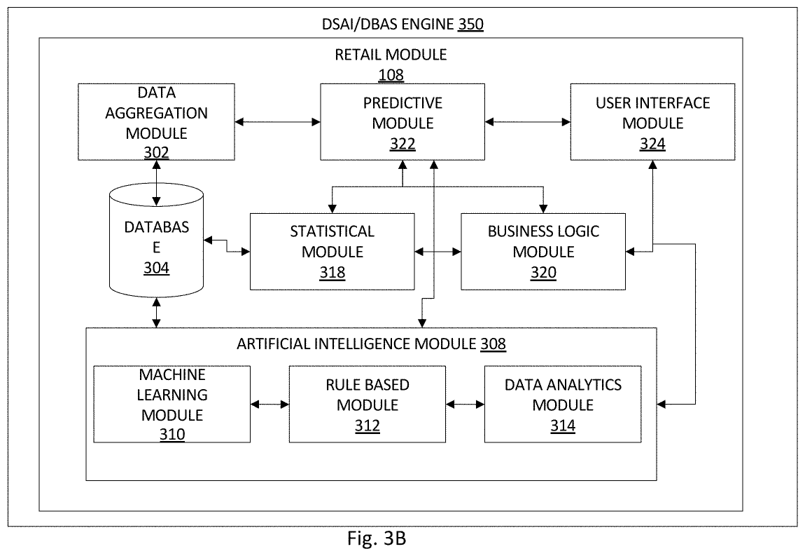

FIG. 3A illustrates different parts of a retail module in an embodiment of the present invention. The retail management module 108 includes a data aggregation module 302, a database 304, an artificial intelligence module 308, a statistical module 318, a business logic module 320, a predictive module 322, and a user interface module 324. In addition, the artificial intelligence module 308 includes a machine learning module 310, a rule-based module 312, and an data analytics module 314.

The data aggregation modules 302 aggregates data from different sources including external databases, internal database 304 containing propriety data and other aggregated data from multiple sources. Furthermore, the data aggregation modules 302 may also aggregate data from one or more public sources such as Google maps, government websites and other sources as needed.

In embodiments, the database 304 may be relational database, a distributed database, a standalone database or some other type of database.

In embodiments, the statistical module 318 may implement one or more statistical techniques such as but not limited to regression analysis, correlation analysis, multivariate analysis, discriminate analysis, log analysis or some other type of analysis.

In embodiments, the predictive analysis module 322 may provide prediction based on the input received from one or more sources such as but not limited to statistical module 318, business logic module 320, artificial intelligence module 308 and other modules.

In embodiments, the predictive module 322 may include process and rule-based decision-making algorithms associated with retail management for prediction.

In embodiments, the artificial intelligence module 308 may implement data analytics algorithms in the data analytics module 314. Additionally, the data analytics module 314 may be associated with rule-based module 312 to evaluate different parameters relevant for analysis of different parameters associated with retail management. The artificial intelligence module 308 may further include the machine learning module 310 that implements machine learning algorithms for supervised and unsupervised learning. The machine learning module is interfaced with the rule based module 312 and the data analytics module 314 and act in unison for data analysis and training of algorithms.

FIG. 3B illustrates a DSAI/DBAS Engine 350 in an embodiment of the present invention. In this embodiment, the retail management module 108 may reside in the DSAI/DBAS Engine 350. Further DSAI/DBAS Engine 350 may include additional modules apart from the retail management module 108.

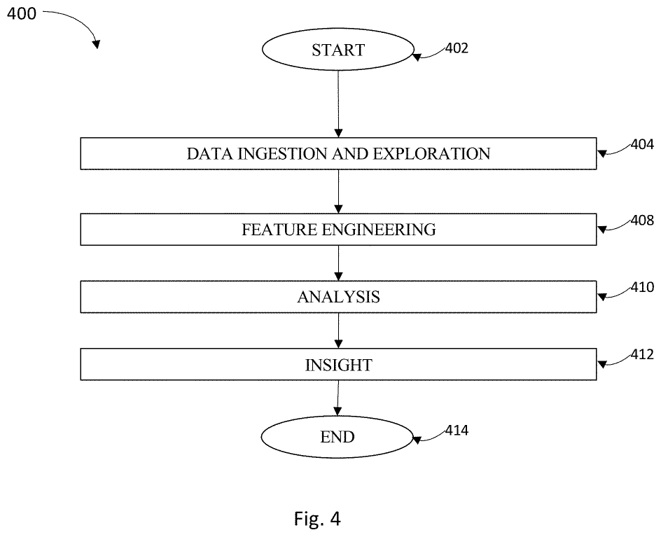

FIG. 4 illustrates the process of data selection and transformation of data into insightful data for business decision making. The process 400 is initiated at 402 and moves to step 404. At step 404 the process 400 will start with utilizing the data for a specific problem, developing an intricate data infrastructure that incorporates different business operations. At step 408, the process 400 may initiate feature engineering by layering data with proprietary data to prepare a network. Subsequently, at step 410, the aggregated may be analyzed by using artificial intelligence and machine learning algorithms to identify relevant features affecting a business. Finally at step 412, the process 400 may provide insights about different aspects, such as customer profile, new location for expansion, cross channel sales affecting business and right marketing platform. The process 400 terminates at step 414.

In some embodiments, the process 400 may starts with data cleansing in the DSAI/DBAS Engine, which is the core of the invention. The DSAI/DBAS Engine collects and aggregates data, which is cleansed based on predefined criteria. The DSAI/DBAS Engine then analyzes the existing data to understand the performance of each store, which is drilled down to each product level. Each internal product category level sales data is then subjected to constraints depending on which stores are able to achieve a minimum sales target.

In embodiments, the information about a brand's customer may reside outside the databases of the brand/company. In an exemplary implementation, when working on a new location, there is negligible amount of internal data available to substantiate the success or failure of the store. Therefore, a data driven approach is taken to create a comprehensive profile of catchment area around current stores and use it to identify important characteristics which leads to success of the stores. Subsequently, the DSAI/DBAS Engine tries to find locations with similar or better characteristics. The next step is to categorize the success and unsuccessful store based on available data. Taking that as the dependent variable, DSAI/DBAS Engine models it against independent variables related to customer demographic, catchment attributes, competition and commercial activity around the store.

In embodiments, the characteristics of the customer in the catchment area are used as independent variables to model the dependent variable, that is, success of the store. The characteristics of the customer in the catchment area may include but not limited to purchasing power of the customer, population, demographics, volume and type of commercial activity, competition and geo-mapping.

In embodiments, the unique and novel feature may be to utilize geospatial data for analysis and to interpret store performance in the context of geo-social factors. Furthermore, incorporation of different factors such as but not limited to commercial activity and purchasing power as determined by different wealth indices, the DSAI/DBAS Engine can predict the relevant features responsible for the success or failure of the store.

In different embodiments, different combination of data from multiple data sets are used to predict one or more parameters that play a part in the success of a store. The DSAI/DBAS Engine uses amalgamation of internal data, public data, external data as well as paid external data to predict at least one parameter.

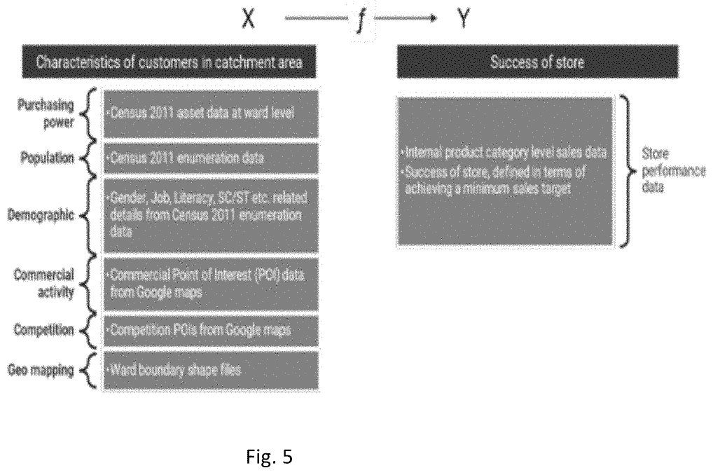

FIG. 5 illustrates different characteristics of customers for prediction of a store location in an embodiment of the present invention. In embodiments, the different sources may include purchasing power of potential retailers, population, customer demographics, data performance, customer archetype, commercial activity, competition and mapping. In the embodiment in FIG. 5, ward boundary data may be obtained from geo mapping data and the other demographic and commercial data may be obtained with reliance mainly on publicly available data or be obtained from internal data sources.

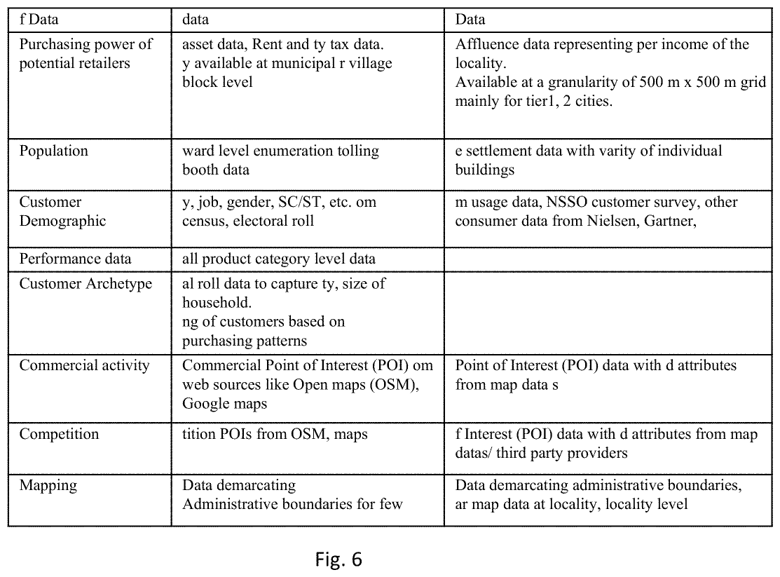

FIG. 6 illustrates a table of different characteristics of customers for prediction of a store location in an embodiment of the present invention.

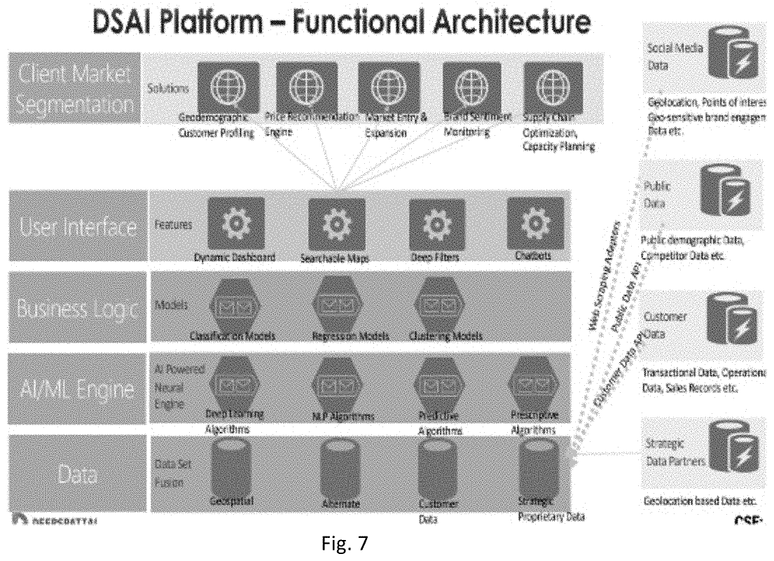

FIG. 7 illustrates the functional architecture of DSAI platform/DBAS platform in an embodiment of the present invention. The first layer comprises client market segmentation that can be categorized under but not limited to geo-demographic customer profiling, price recommendation engine, market entry expansion, brand sentiment monitoring, and supply chain optimization and capacity planning.

Each of these databases/data aggregators can be provided externally or maybe inbuilt within the DBAS platform/DSAI platform as shown in the FIG. 7. The geo-demographic profiling provides customer related information with respect to age, income, caste, creed, preferences, and consumer behavior. The price recommendation engine includes an artificial intelligence platform that allows customer segmentation and price sensitivity related information about each customer. Likewise, market entry and expansion provide assessment of opportunity for opening a new store at a new location or current expansion opportunity availability.

Brand sentiment monitoring may be an important aspect in consumer behavior that can provide information related to brand affinity and brand preference of the customers in the specific locality. It provides specific information related to brands that a store needs to keep in order to increase sales and/or understand the consumer behavior in a much better way to promote other brands. The supply chain Optimization Can provide important insights related to how the organization of goods and services, for example, what is the capacity? What is the inventory level that a particular store needs? All this information helps in understanding the retail management of a particular store or to identify new store locations.

The second layer comprises a user interface which includes dynamic dashboard, searchable maps, deep filters and chatbots. The dynamic dashboards may display information related to various aspects of Retail Management including customer preferences, price recommendation, market expansion opportunities, brand affinity and inventory levels.

The third layer comprises business logic which comprises different models for example, classification models, regression models, clustering models or some other type of models as known in statistical analyses. Each statistical model may be applied based on the type of data and analysis required.

The fourth layer comprises artificial intelligence/machine learning engine. The artificial intelligence powered neural engine implements deep learning algorithms, Natural Language Processing algorithms, predictive algorithms and prescriptive algorithms. All these algorithms may be stored in a database and may be implemented based on the needed analysis/problem related to specific retail management.

The fifth layer includes data layer level which includes data from geo-spatial repository, alternate repository, customer repository and strategic repository. The geo-spatial repository database includes social media data but is not limited to geo-location, points of interest, geo-sensitive brand engagement and other such data. The alternative repository may include public data, such as but not limited to, public demographics data, competition data and other type of data. The customer repository may include data, such as but not limited to, transactional data, operational data, sales record data, brand data such as consumer behavior data. The strategic proprietary databases may include geo-location-based data related to demographics and population distribution in an around the said area.

Each of these databases can be connected through internet to a distributed system which may collect relevant data and get updated over a period of time. Furthermore, in some embodiments, the data layer may implement certain APIs to extract data form distributed database.

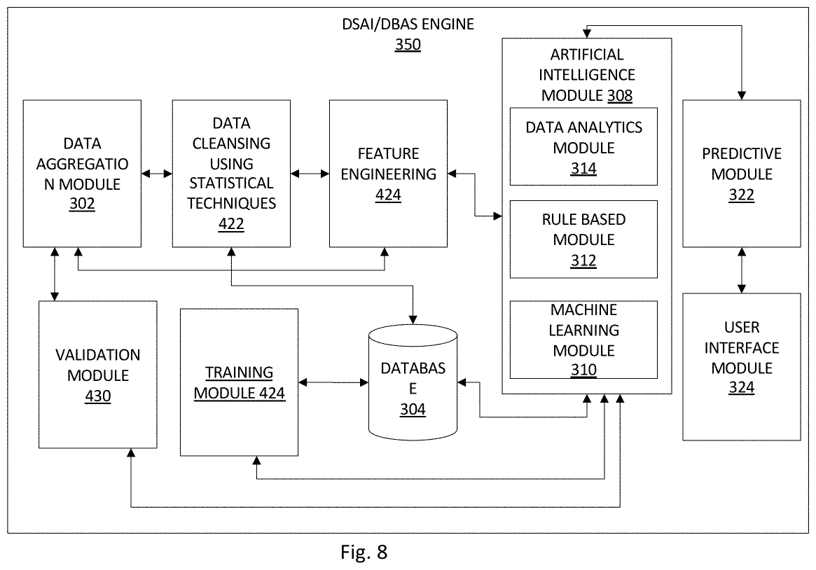

FIG. 8 illustrates another architecture of the DBAS/DSAI platform in another embodiment of the present invention. The DBAS/DSAI platform includes a DBAS/DSAI Engine 350. The DBAS/DSAI Engine 350 may include the data aggregation module 302, a data cleansing module 422, which may use statistical techniques to clean raw data such as eliminating the outliers in the data. The exemplary DBAS/DSAI Engine also includes feature engineering 424 that extract relevant features to form statistical and/or prediction model. The exemplary DBAS/DSAI Engine also includes the artificial intelligence module 308, which may further include machine learning module 310, rule based module 312 and data analytics module 314 which in conjunction with algorithms providing prediction capabilities may provide a predicted outcome through a prediction module 322. A user interface 324 in the DBAS/DSAI Engine provide tangible results to the user to make data driven decisions.

In addition, the DBAS/DSAI Engine 350 further includes database 304, training module 424 and a validation module 430.

In some embodiments, the training module 424 may be trained to perform prediction and the result may be verified by using a validation module 430.

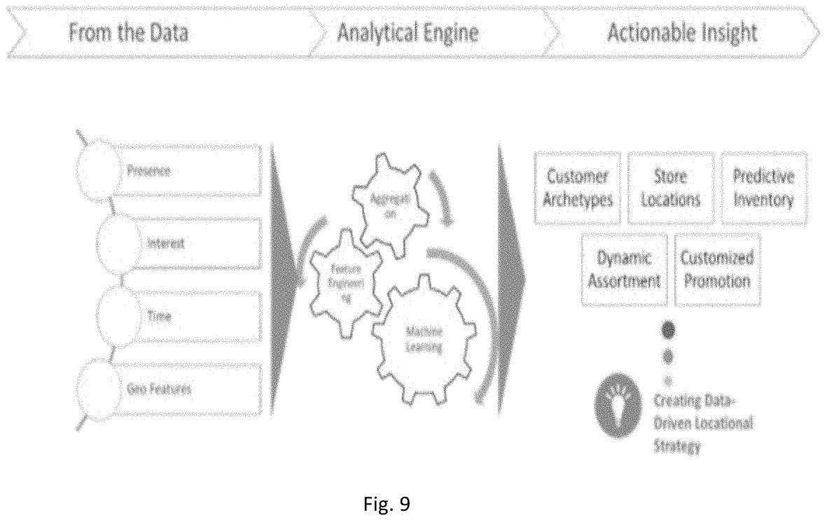

FIG. 9 illustrates a functional flow in evaluation of a store location in an embodiment of the present invention. The functional flow starts with data analysis. The different type of data may be aggregated such as presence data, interest data, time, and geo-spatial data. All the aggregated data is passed to the analytical engine that may perform aggregation, feature analysis, and machine learning. After performing analytics on the data, the actionable insights may be provided such as but not limited to customer archetypes, store locations, predictive inventory, dynamic assortment, customized promotions, and other insights.

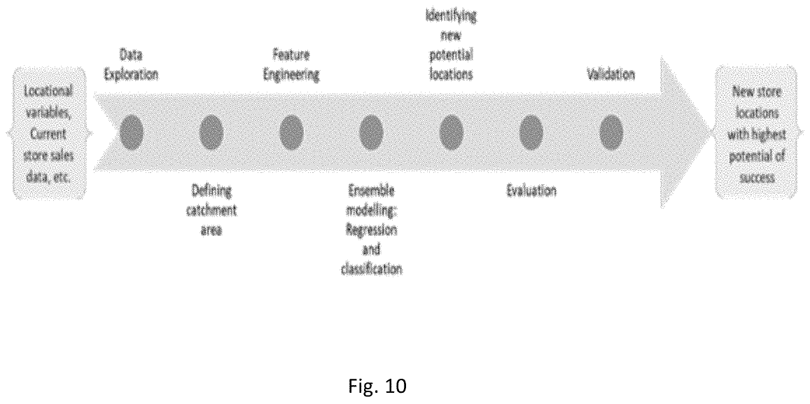

FIG. 10 illustrates a process flow of evaluation of a store location in an embodiment of the present invention. The process starts with data exploration followed by defining catchment area, feature engineering, ensemble modeling, identification of new potential locations, evaluations, and validation to predict the new store location based on one or more different variables.

The DBAS/DSAI Engine uses the data exploration approach of visual and statistical exploration to understand the available data and the characteristics of the data like the size or amount of data, ensuring standardization of the data from various sources, discarding fields with no variability or utility due to missing values, etc. and other possible relationships amongst various data elements and target variable (success of the store).

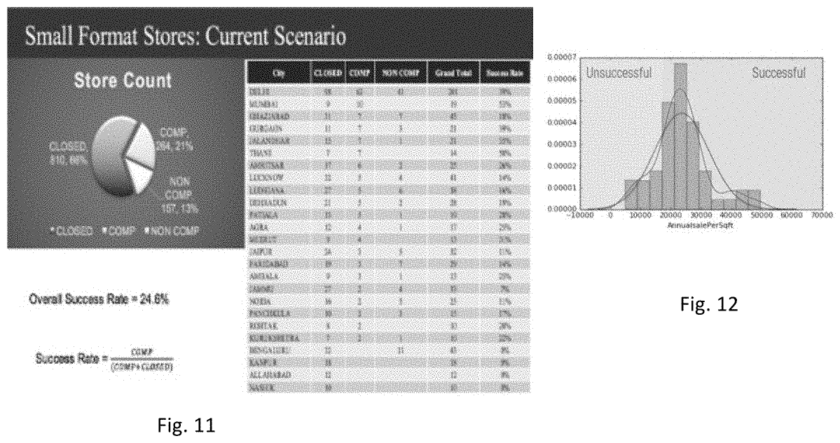

FIG. 11 illustrates an exemplary case of data exploration for small format stores in an embodiment of the present invention. The exemplary case includes data of comparable stores (COMP), non-comparable stores (NON-COMP), and the closed stores (CLOSED). The non-comparable stores are the stores which have opened within the last one year and hence are not comparable to older stores which have matured in operations. In this exemplary analysis, store with more than one year of age has been considered. The data may further include closed stores, which are stores that were not operational at the time of analysis. Reason for closure is not provided in the data and it may include stores which were planned but never opened.

FIG. 12 illustrates the DBAS/DSAI Engine performing a correlation analysis of the annual store level sales data with respect to floor area. The correlation analysis shows that floor area of the store is highly correlated to the sales. To remove the impact of this correlation, all other features are studied against Annual Sales per Sq. ft. The probability distribution of annual sales per sq. ft. shown above has a sudden drop at 20,000. This break point is used to define and bifurcate stores into successful and unsuccessful categories.

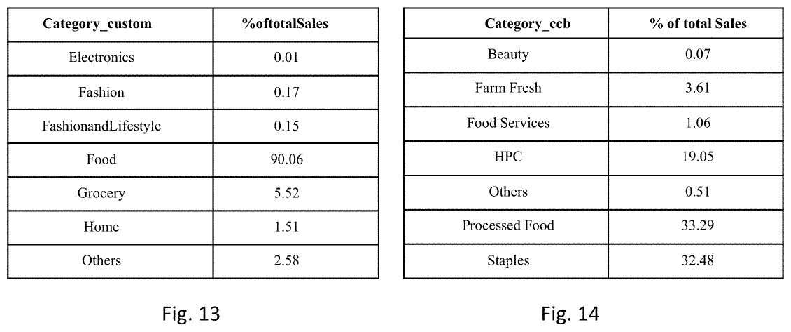

FIG. 13 illustrates the contribution of the different product categories to sales. The DBAS/DSAI Engine may include an application for analysis of each category level sales wherein the internal sales data is studied with respect to category of products being sold. This exploration check may be performed even if the catchment level feature does not relate to overall sales, as it may relate to the sale of a category of products. The output for contribution of the different product categories to sales are illustrated in the accompanying figures.

Further, in this exemplary embodiment, it is inferred that the small store is dealing with grocery items, observably, ‘Food’ which was the major contributing category to overall sales. Therefore, ‘Food’ category is further explored in more detail using the ‘category ccb’ attribute as shown in table under FIG. 14. This leads to the conclusion that processed food, staples and HPC cover almost 85% of the food category sales.

In embodiments, the correlation among sales of sub-categories within Food category is analyzed to identify any major subcategory, which may behave differently from other subcategories. The prominent subcategories such as processed food, staples and HPC were found to be highly correlated. In some embodiments, the DBAS/DSAI Engine may produces a heat map of correlation.

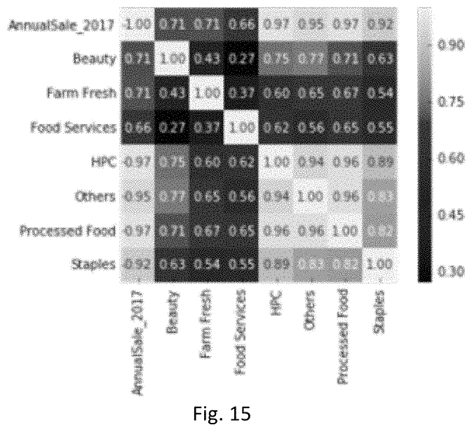

FIG. 15 illustrates a heat correlation map of the product subcategories inside food category. The correlation among sales of sub-categories within food category is analyzed to identify any major subcategory, which might be behaving differently from others. All major subcategories, processed food, staples and HPC were found to be highly correlated. The DBAS/DSAI Engine produces a heat map of correlation as shown in FIG. 15.

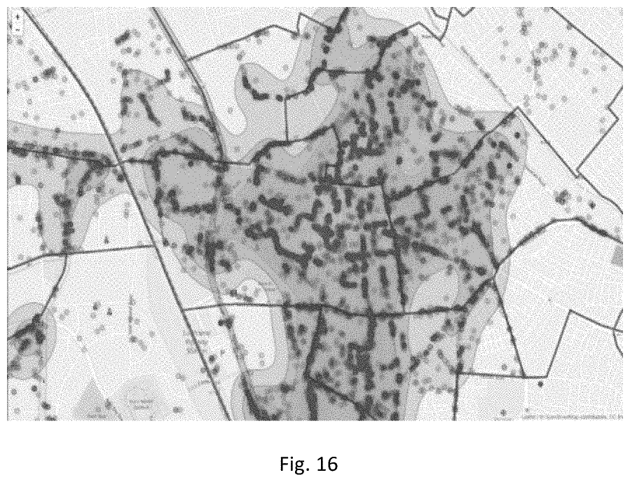

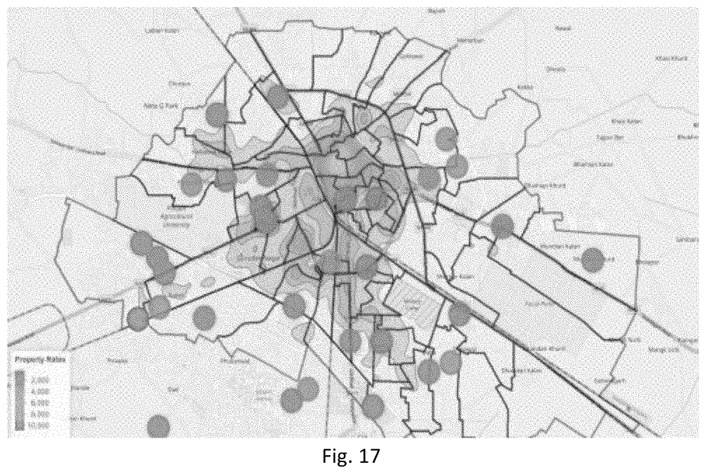

FIG. 16 illustrates commercial density contours that include all commercial Point of Interests (POI). The analysis may use different variables, such as but not limited to demographic, economic, commercial and competition related attributes of cities are analyzed spatially on geographic maps to study their variation. The analysis produces commercial density contours. The commercial point of interests are plotted in green color. Likewise, the municipal ward boundaries are shown in blue color. The analysis of commercial densities helps in identifying the major commercial hubs of the city. Based on the type of problem, the DBAS/DSAI Engine takes appropriate analysis. For example, in this case, it's the hierarchical clustering approach for identifying commercial hubs in the city within a stipulated intra-cluster distance.

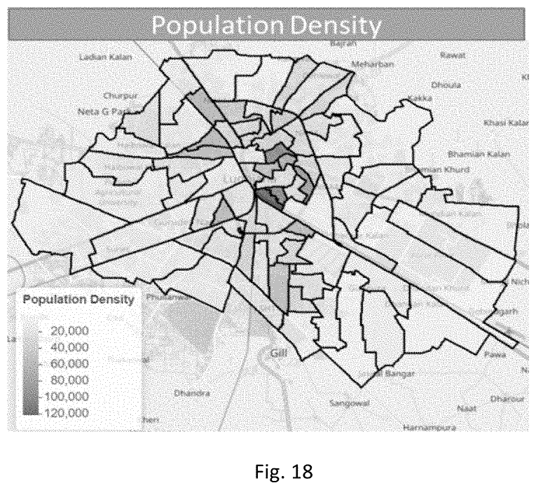

FIG. 17 illustrates the locality level property rates data for the exemplary city. In this example, the commercial property rates data is mapped over the top of the commercial density contour, that is, locality level property rates, aggregated from property related various websites are used to augment the census data.

FIG. 18 illustrates a population density map used to understand the demographics of the city. The population density map provides information about the density of population in each locality/area of the exemplary city.

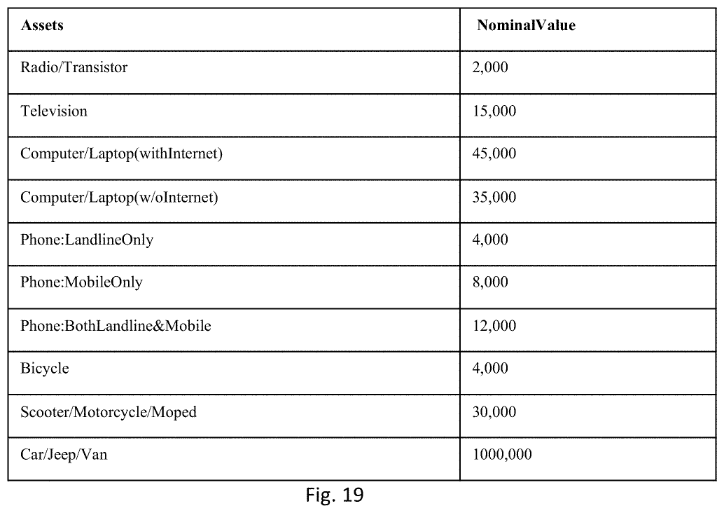

FIG. 19 illustrates the asset data of each household of an exemplary city in an embodiment of the invention. The asset data shows the ownership of different type of assets and the number of people owning these assets.

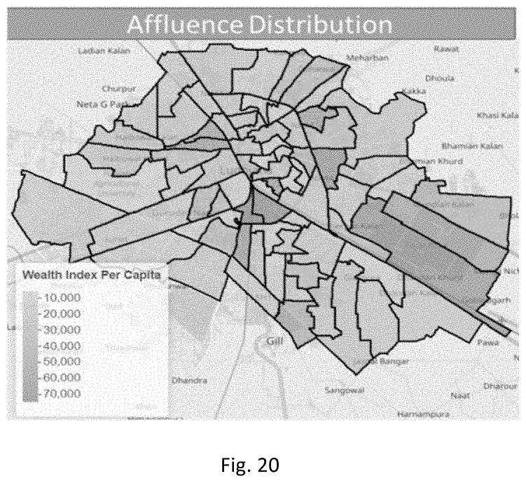

FIG. 20 illustrates the affluence distribution for the exemplary city in an embodiment of the present invention. Affluence distribution is a measure of the asset data provided as percentage of households owning the asset. The affluence distribution may be taken from census, which often acts as an indicator of the purchasing power of the potential customers living in a particular area.

In some embodiments, this is closely related to disposable income as compared to other asset parameters, like material of house building, sanitation, kitchen and water facilities, etc.

Using the asset ownership data, an indicative wealth index per capita is created by assigning nominal value to each of the listed asset and then calculating a weighted index as described below. This index helps in studying the relative affluence of different wards and catchments.

Wealth Index Per Capita=(Σ(Pᵢ*Vⱼ)*Households)/Population

Where,

Pᵢ: % of households with Asset i

Vⱼ: Nominal value of Asset i

Households: No. of households in ward

Population: Population of the ward

The affluence distribution may be one of the key factors in determining the location of the retail store within the exemplary city.

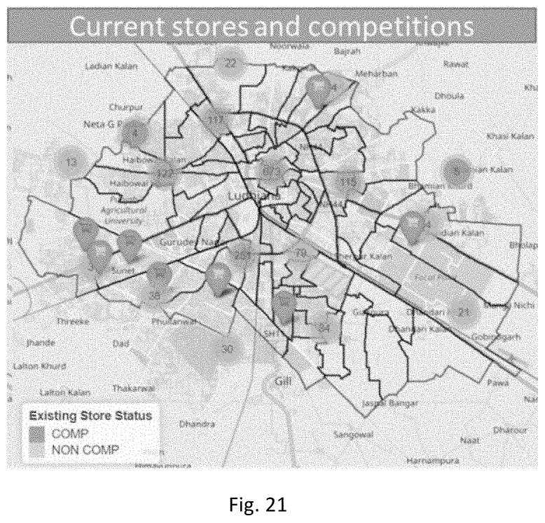

FIG. 21 illustrates location of current and competition stores for an exemplary city in an embodiment of the present invention. In embodiments, the point of interest (POI) data may be collected from open street map and Google maps. The data collected from the point of interest may include tags related to the activities/services/business type provided by the point of interest. For example, mechanic, bank, temple, fire station, mall, etc. “Grocery”, “Super Market”, “Department Store”, “Convenience Store” tags may be used to identify stores that may offer competition.

The location markers in FIG. 21 represent the locations of the small format stores along with different shaded markings in the location marker indicating that store's status of competition and non-competition respectively. The circle markers with a number highlight the number of competition stores in those zones. The output indicates that there are geographical pockets in the city ranging in competition density from low to high. Accordingly, inference can be drawn based on the current location of store that all locations of the city are not equally good for opening a new store.

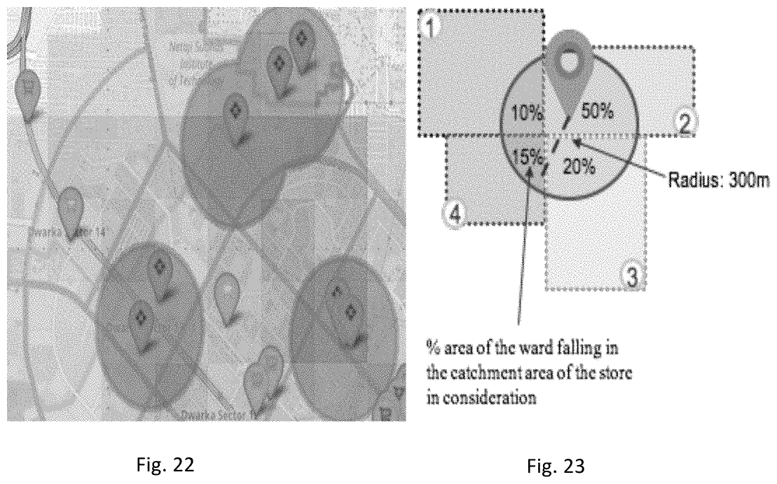

FIG. 22 shows the exemplary catchment area calculations for a city in an embodiment of the invention. Catchment area is the region around the store which can be serviced by the store. Based on the type of target customers and the products being sold, the size of the catchment area of a store can vary.

Referring to FIG. 23, for a small format store, the analysis is done by taking multiple catchment areas with store as center and radius of the circle as 300 meters, 500 meters, 1 Km and 1.5 Km.

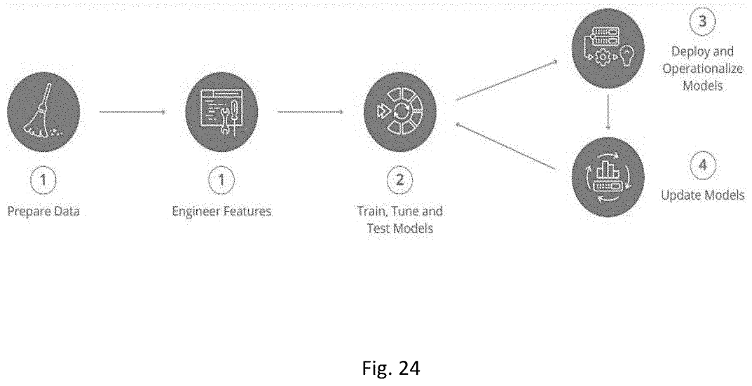

Referring to FIG. 24, any feature of the catchment area X may be calculated as the weighted sum of population of each ward falling under the catchment area. In determining the catchment, one assumption is that the distribution of all ward level attributes is uniform within the ward. There are some cases where ward level attributes may not be known. Only those stores where at least 90% of catchment area falls in wards with known attributes may be considered in analysis using:

Population Density=(Σ(wᵢ*Populationᵢ)/πr²

where,
wᵢ: % of area of ward i falling in the catchment area
Populationᵢ: Total population of ward i
r: radius of catchment area

The process may involve the steps of preparing the data, engineering the features depending upon the type of store and retail segment, training and tuning the models to predict the probability of success of a store followed by deploying the models. The results obtained over time may be added to the available data and the learnings applied to update the models.

Referring to FIG. 24, the process for feature engineering starts with data preparation, engineering features, train, tune and test the model, update model and deploy and operationalize model.

In embodiments, features may be calculated for the catchment area based on census and POI data. Feature engineering may be performed with an objective for that feature set to capture true sense of population attributes and location attributes for that catchment area.

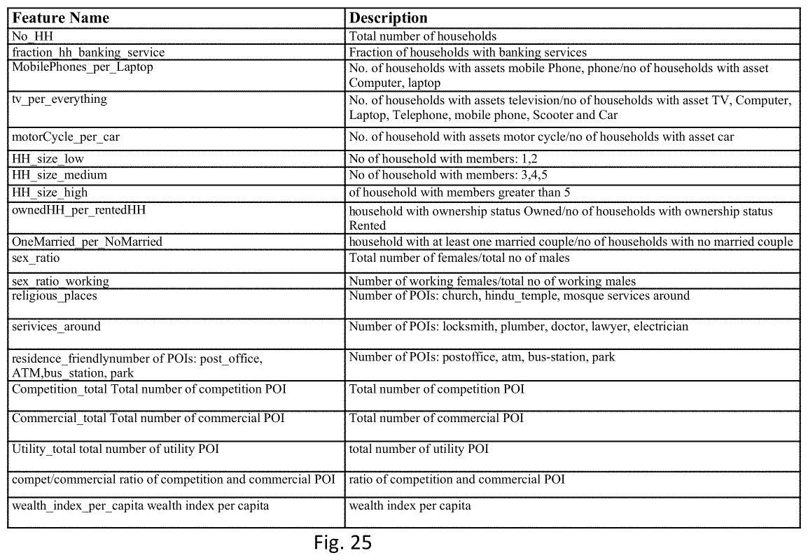

FIG. 25 illustrates significant features in an exemplary case of feature engineering for a small store location in an embodiment of the present invention. One aspect of statistical modeling and traditional Machine Learning (ML) is to provide extensive features to the algorithm, so that the output can explain the variations in the target variables (sales or success of store in this context). Feature engineering tries to increase the explanatory power of input variables. For example, daily sales may not explain sudden jumps in sales, but bifurcating that as weekend and weekday sale may help determine if major customers are homemakers or people employed in 9-5 jobs.

In embodiments, a large number of features may be created using the available data categories and subcategories. In the embodiment the number of features were limited to strike a balance between the objective of capturing true sense of population attributes to provide enhanced explanation of the correlation while at the same time avoiding the curse of unmanageable complexity due to increased dimensionality.

FIG. 25 illustrates a table of features with signification contribution to the model for determining the location of a store in an embodiment of the invention.

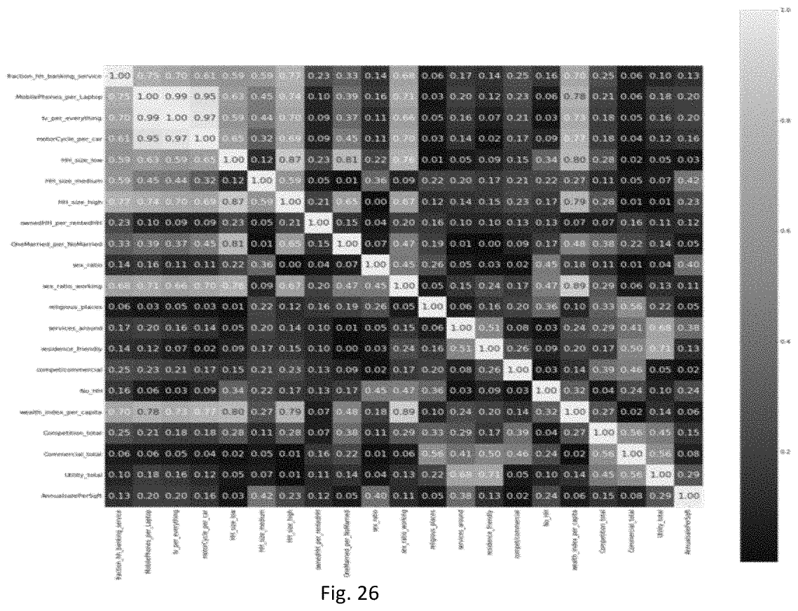

FIG. 26 illustrates correlation heat map of significant features of an exemplary case in an embodiment of the present invention. Once the correlation heat map has been obtained, the processes of discarding the highly correlated features is performed. For example, in the table of FIG. 25 the features such as, “tv_per_everything” and “motorbCycle_per_car” may be dropped at this stage.

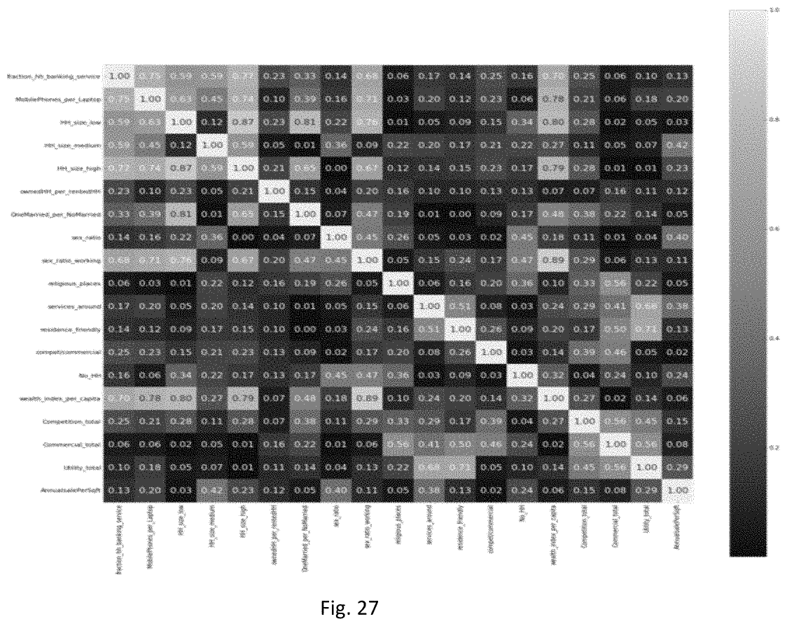

FIG. 27 illustrates correlation heat map of significant features of an exemplary case after the highly correlated features are removed in an embodiment of the present invention. By removing the highly correlated features the analysis results may be more unbiased.

As a next step data modeling is performed. The data modeling is performed using machine learning techniques. The prime objective of the data modeling is to establish a relationship between the characteristics of the store's catchment area (demographics, economical, commercial activity, competition, etc.) to its sales. For example, is there an impact of population of working females in the area on the sales of a store? If yes, how to quantify it. How is general commercial activity in the area or number of competitors going to impact the sales?

Based on volume of data, the DBAS Engine machine learning (ML) algorithm considers hundreds and thousands of such questions and calculating its combined impact on the sales of the store. In case, the number of existing stores is less, it becomes difficult for advanced machine learning algorithms to establish a relationship between characteristics of the catchment area to its sales. In this scenario, the problem may be solved in different ways.

In some embodiments, the data model is configured to predict the success or failure of store in terms of meeting a minimum sales target using a classification approach.

In some embodiments, the data model is configured to predict actual store ranking in terms of higher sales-regression approach. In this approach, for regression, ‘Annual Sales Per Sqft’ is used as a target variable as this variable incorporates store area. Also, distribution of ‘Annual Sales Per Sqft’ is closer to a normal distribution, compared to ‘Annual Sales’. In the exemplary embodiment, there were 18 features and very few data points were analyzed/employed to arrive at simpler models such as, but not limited, to lasso and ridge regression, MARS, KNN regression, average of lasso, ridge and MARS and other such types of statistical models.

In some embodiments, each catchment radius for the models may be validated using cross validation.

In some embodiments, the goal for the regression model is to recognize store ranking with respect to “Annual Sale Per SqFt” so for model selection the software model used was Kendall's Tau metric. This metric is used to calculate ordinal association between two measured quantities. In this context, ranks are assigned to the store based on their real and predicted sales, and more the real and predicted rank matches, the higher the Kendall's Tau.

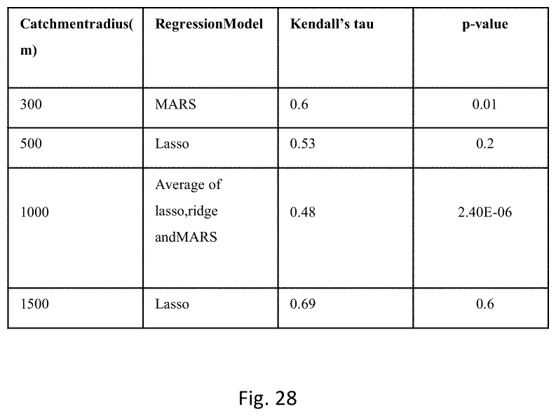

FIG. 28 illustrates the Kendells Tau metric for various catchment areas in an embodiment of the present invention. In this exemplary case, the Kendells Tau Metric for various catchment areas are provided. Likewise for classification of Annual Sales Per Sqft is divided into successful and unsuccessful using minimum 20,000 as the criteria for a successful store.

In certain embodiments, as a next step, model selection may be performed by validating different sets of hypothesis such as feature interaction and non-linearity.

In some embodiments, if there is paucity of data, only simple hypothesis such as linear model may be tested.

In some embodiments, the model may suffer from over fitting such as in case where there are a very few data points. In this case, a logistic classifier may be used with L2 regularization to avoid over fitting. For each catchment radius different model may be created.

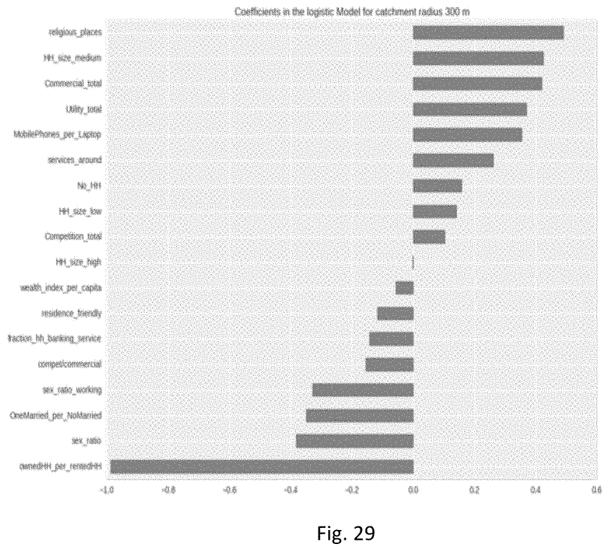

As shown in FIG. 29, in an exemplary model the importance of features is applied to a model with a catchment radius 300 m. For example, the table analyzes the coefficient of feature making contributions to the logistic model.

In some embodiments, subsequently after the model selection, the model validation may be performed. In some embodiments, the validation of results may be done in tandem with creation of the model.

During the validation process, a set of data points related to sales information for certain existing store are kept aside and are not provided to the machine learning model. After the model is trained, the model is validated to calculate the store's success probability. Thereafter, the model is validated using the validation data to find its proximity to with real world. 80-20 split is made at random to get training and validation data for each catchment radius.

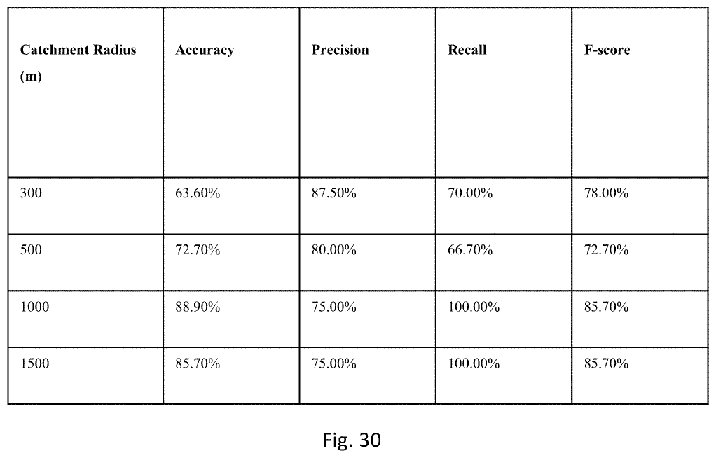

As shown in FIG. 30, in an exemplary model the catchment radius is analyzed with respect to features for model validation. For example, the table analyzes validation of the catchment radius with respect to accuracy, precision, recall and F-score.

In an embodiment, the DBAS/DSAI Engine may take an unsupervised learning/hierarchical clustering approach. The unsupervised learning may be used to identify areas where a lot of commercial POIs are in close proximity taking that as a sign of a marketplace, and as a consequence, mark the said location as an economic zone or a potential store location. In some embodiments, additional filters based on business requirements may be applied on this set of locations.

In some embodiments, in order to identify potential store locations having same characteristics as followed in the previous steps are calculated and passed to the machine learning model to evaluate the success probability as an indicator of feasibility whether a store can be opened at the location. This acts as a filter and locations with low chances of success may be dropped. In the next step, the regression model helps in ranking these locations in terms of higher to lower sales potential.

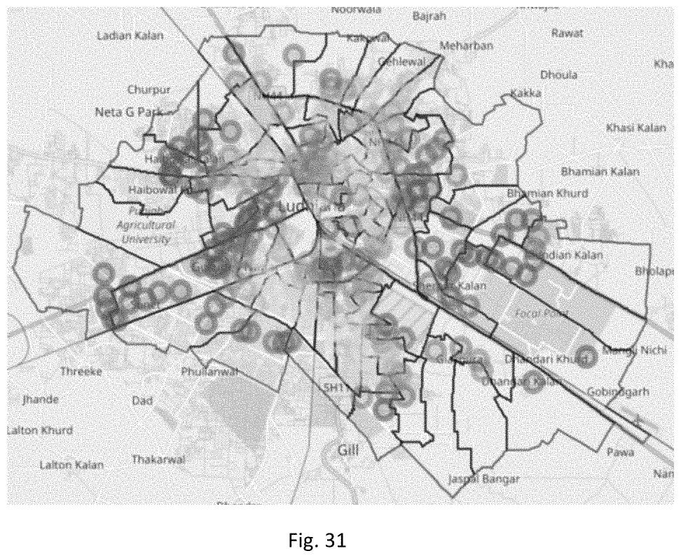

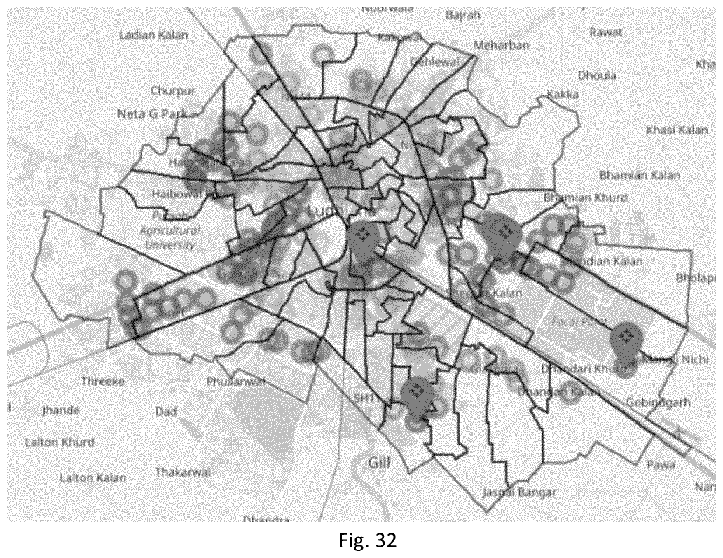

In some embodiments, where more than one store are to be opened, an optimization algorithm such as Genetic algorithm (GA) may be then used to select locations in such a way so that cases of one store cannibalizing into other can be avoided and the overall sales through these stores is maximized. That gives the final set of new store locations. The DBAS Engine produces the representation shown in FIG. 31, which illustrates the new locations with site potential marked from low to high, darker to lighter, respectively.

Likewise, as shown in FIG. 32, the DBAS Engine provides a Snapshots from LOCI identifying new store locations with given constraints (location markers).

In embodiments, the validation of the data model is followed with optimizing the picking of stores with respect to minimum/maximum distance constraints, including supply chain driven constraints of the new store locations in terms of minimum and maximum distance from the nearest existing store, as well as other recommended new stores. It may be solved by converting it into a Mix Integer Programming problem as described below.

Relevant parameters:
1. Number of potential commercial hubs=n
2. Minimum distance constraint=min_dist
3. Maximum distance constraint=max_dist
4. Number of existing stores=p
5. Number of Stores to open=k
6. (Vector X: n×1) where xᵢ: Binary (0,1) variable indicating whether store opened or not at commercial hub i
7. (Vector Y: n×1) where yᵢ: Annual Sales per sq feet prediction for commercial hub i
8. (Distance Matrix D: n×p) where dᵢⱼ: Distance between commercial hub i and existing store j
To solve the equation, one has to maximize total sales: ΣY*X^{T} subject to given constraints using the following formulae:

Total New Stores to be opened: Σxᵢ=k(i=1,2, . . . ,n)

Binary variable constraint: xi∈(0,1)∀(i=1,2, . . . ,n)

Min distance from existing store: min(dᵢⱼ*xᵢ)>=min_dist Where(j=1,2, . . . ,p)

Similar constraint∀(i=1,2, . . . ,n)

Max distance from existing Store: max(dᵢⱼ*xᵢ)<=max_dist Where(j=1,2, . . . ,p)

Similar constraint∀(i=1,2, . . . ,n)

In embodiments, the DBAS Engine UI/UX may have all features related to data ingestion and exploration, feature engineering, insights, analysis, results and presentation dashboard. In embodiments, the DBAS UI/UX may allow users to effectively complete a task or achieve a specific goal, like store relocation, sales comparison, market expansion etc. Additionally, the DBAS/DSAI Engine may have the Natural Language Processing (NLP) feature where the retail management application can understand any question posed by the user in natural language.

In embodiments, the user interface may allow users to click various tabs, and apply filters, run what-if analysis on the data.

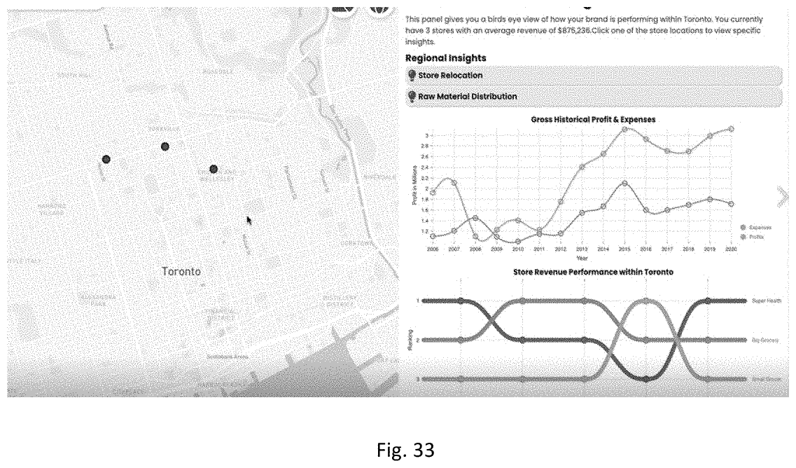

FIG. 33 illustrates an exemplary UX/UI is showing the performance of the brand in an exemplary city.

The disclosed invention accounts for various business drivers and their contribution to retail success. The methodology implemented in the methods and systems disclosed, takes into consideration the demand points which may be the population centres, the major competitors as well as major business drivers which may comprise of relevant POIs such as affluent population, target population in specific age groups, the connectivity of the area, and the overall socio-economic status of the target population. In the methods and system disclosed, based on an extensive scraping, cleaning, processing, selecting optimal set of parameters and subsequent feature engineering, the retail potential may be calculated. In certain embodiments, the outcome of the analysis may be validated on the basis of maximum attendance i.e. the predicted annual visits to the proposed retail location and target market share. In practice, the annual visits is directly proportional to the sales potential of the location. In different embodiments, the uniqueness of the analysis and predicted decision points lies in defining the catchment area of a retail location, feature engineering for selecting the most critical factors or parameters affecting the retail potential of a particular location, forming an optimal set of these factors or business drivers to calculate the retail market potential hotspots.

For evaluation of the technique and the result in terms of a new location for opening a successful retail store, the target market share after taking the competition into account may be calculated and also the tickets to be generated per day may be predicted using an optimization technique. This optimization algorithm may calculate the maximum attendance from the demand points/population centers in the vicinity based on the specified impedance. The impedance can be characterized as the maximum distance to be travelled by a potential customer or maximum time travelled by the prospective customer to reach the desired location. The tickets generated/maximum annual visits would change with the values of the impedance. The more conservative the values of the impedance, the lesser would be the annual visits. For scenarios where more than one store is to be opened, the disclosed system and methods may utilize optimization algorithms such as Genetic algorithm (GA) to propose the final set of new store locations and a comprehensive network analysis may be performed to analyze and rank these locations on the basis of target market share and expected annual visits. The best stores can then be chosen from this ranked list.

In some embodiment, a computer implemented method for retail management may be implemented having a processor configured to a memory, the processor configured to execute encoded instructions to perform the steps of gathering geospatial information related to retail management in a DBAS Engine, receiving data related to retail management in the DBAS Engine, selecting a parameter associated with retail management, analyzing the selected parameter associated with retail management in the DBAS Engine, predicting the outcome using the analysis in the DBAS Engine based on the parameter associated with the retail management, and providing data driven decision choices based on the prediction.

In embodiments, the data driven decision choices may be presented through a user interface. In embodiments, multiple parameters may be selected and the step of analyzing the selected parameter may be performed as a layered analysis by overlaying the selected multiple parameters when performing the analysis. In other embodiments, the layered analyses may be performed through use of an artificial intelligence algorithm. Such analysis may be used to identify a preferred customer profile or to identify one of the selected parameters as the parameter with most impact on revenue. In embodiments, the analysis may be used to identified untapped market and/or a new industry vertical. It can further be used to identify choices to optimize capital allocation, improve margins, and enter new markets or to reduce capital expenditure on redundant inventory. In yet other embodiments, the layered analysis may be used to provide information for personalized marketing efforts for preferred customer profiles.

Certain embodiments may practice the disclosed systems through a computer implemented system for retail management comprising a computing platform configured to implement an artificial intelligence engine along with a database, the database may be configured to a DBAS Engine to gather geospatial information related to retail management. Furthermore, the artificial intelligence engine may be configured to a memory comprising artificial intelligence algorithms; and the DBAS Engine may use the artificial intelligence engine to execute the artificial intelligence algorithms to provide data driven decisions related to a parameter associated with retail management. In embodiments the above system may further include a user interface to communicate the choices and decisions to a user of the system.

In certain embodiments, the artificial intelligence engine may execute the artificial intelligence algorithms on multiple subsets from a set of chosen parameters relevant to retail management in a layered solution to provide the data driven decisions related to the chosen set of parameters. In certain embodiments the implemented system may be used to identify the preferred customer profiles, choices to increase revenue through market expansion, hidden markets and new industry verticals. Certain embodiments of the system may identify choices to optimize capital allocation, improve margins, and enter new markets or identify choices to reduce capital expenditure on redundant inventory.

### CONCLUSION

Methods and system for retail management and optimization are described. Although specific embodiments are illustrated and described herein, it will be appreciated by those of ordinary skill in the art that any arrangement, which is calculated to achieve the same purpose, may be substituted for the specific embodiments shown. This application is intended to cover any adaptations or variations. For example, although described as applicable to retail segment using tacit retail industry data in conjunction with geospatial data, and certain parameters relevant to the retail segment, one of ordinary skill in the art will appreciate that the invention is applicable to other environments, such as, utilization of other parameters that may impact retail markets, where there may exist a need to analyze the impact of such other parameters when making decisions on locating specific types of retail stores in a particular area.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments.

We claim:

1. A computer implemented method for retail management having a processor configured to a memory, the processor configured to execute encoded instructions to perform the steps of:
gathering geospatial information related to retail management in a DBAS Engine;
receiving data related to retail management in the DBAS Engine;
selecting a parameter associated with retail management;
analyzing the selected parameter associated with retail management in the DBAS Engine;
predicting the outcome using the analysis in the DBAS Engine based on the parameter associated with the retail management; and
providing data driven decision choices based on the prediction.

2. The computer implemented method for retail management of claim 1 wherein the step of providing data driven decision choices presents the choices through a user interface.

3. The computer implemented method of claim 1, wherein the step of selecting a parameter selects multiple parameters and the step of analyzing the selected parameter is performed as a layered analysis by overlaying the selected multiple parameters when performing the analysis.

4. The computer implemented method of claim 3 wherein the layered analyses is performed through use of an artificial intelligence algorithm.

5. The computer implemented method of claim 3 wherein the layered analysis is used to identify a preferred customer profile.

6. The computer implemented method of claim 3 wherein the layered analysis is used to identify one of the selected parameters as the parameter with most impact on revenue.

7. The computer implemented system for retail management of claim 3, wherein the data driven decision choices include one of an identified untapped market and an identified new industry vertical.

8. The computer implemented system for retail management of claim 3, wherein the data driven decision choices include choices to optimize capital allocation, improve margins, and enter new markets.

9. The computer implemented system for retail management of claim 3, wherein the data driven decision choices include choices to reduce capital expenditure on redundant inventory.

10. The computer implemented system for retail management of claim 5, wherein the data driven decision choices include information for personalized marketing efforts for preferred customer profiles.

11. A computer implemented system for retail management comprising:
a computing platform configured to implement an artificial intelligence engine;
a database, the database configured to a DBAS Engine to gather geospatial information related to retail management;
the artificial intelligence engine configured to a memory comprising artificial intelligence algorithms; and
the DBAS Engine using the artificial intelligence engine to execute the artificial intelligence algorithms to provide data driven decisions related to a parameter associated with retail management.

12. The computer implemented system for retail management of claim 11 further including a user interface.

13. The computer implemented system of claim 11, wherein the artificial intelligence engine executes the artificial intelligence algorithms on multiple subsets of a set of parameters relevant to retail management in a layered solution to provide the data driven decisions related to the set of parameters associated with retail management.

14. The computer implemented system of claim 13, wherein the data driven decisions identify the preferred customer profiles.

15. The computer implemented system of claim 13, wherein the data driven decisions identify choices to increase revenue through market expansion.

16. The computer implemented system of claim 13, wherein the data driven decisions identify hidden markets and new industry verticals.

17. The computer implemented system of claim 13, wherein the data driven decisions identify choices to optimize capital allocation, improve margins, and enter new markets.

18. The computer implemented system of claim 13, wherein the data driven decisions identify choices to reduce capital expenditure on redundant inventory.
